(19) United States
(12) Patent Application Publication
(10) Pub. No.: US 2023/0004577 A1
(43) Pub. Date: Jan. 5, 2023

(54) MANAGEMENT DEVICE, MANAGEMENT METHOD, AND NON-TRANSITORY COMPUTER-READABLE RECORDING MEDIUM

(71) Applicant: Mitsubishi Electric Corporation, Tokyo (JP)

(72) Inventors: Hikaru SATO, Tokyo (JP); Masaya HONJO, Tokyo (JP)

(73) Assignee: Mitsubishi Electric Corporation, Tokyo (JP)

(21) Appl. No.: 17/939,610

(22) Filed: Sep. 7, 2022

Related U.S. Application Data
(63) Continuation of application No. PCT/JP2020/018012, filed on Apr. 27, 2020.

(51) Int. Cl. G06F 16/27; G06F 16/23

(52) U.S. Cl. CPC G06F 16/273; G06F 16/2365

(57) ABSTRACT

A management device (100) includes a storage unit and a ledger deletion unit (150). Information indicating a ledger-deleting condition is recorded in the storage unit, the ledger-deleting condition being a condition for deleting a deletion distributed ledger which is a distributed ledger to record distributed electronic data. The ledger deletion unit (150) deletes the deletion distributed ledger if the ledger-deleting condition is satisfied.

### CROSS REFERENCE TO RELATED APPLICATIONS

This application is a Continuation of PCT International Application No. PCT/JP2020/018012 filed on Apr. 27, 2020, which is hereby expressly incorporated by reference into the present application.

### TECHNICAL FIELD

The present disclosure relates to a management device, a management method, and a management program.

### BACKGROUND ART

A distributed ledger is one type of technique for sharing data among a plurality of servers. All pieces of data operation information of the past are held by the plurality of servers. Specific examples of a data operation are data registration and data update. Hence, the distributed ledger has a characteristic that it enables servers to easily monitor data tampering and the like of each other. An example of the distributed ledger is a blockchain. The blockchain is a distributed ledger that generates a unit of data called a “block” and keeps data in a chronological order. Each block contains information that connects a preceding block and a following block to each other. Therefore, when a content of the preceding block is changed, all blocks following the changed block must be rewritten. Since it is difficult to change or delete data once recorded in the past block, the blockchain has high tamper resistance.

In a blockchain, all past data must be stored for verification. Hence, when the blockchain is operated for a long period of time, the storage usage increases linearly and becomes enormous.

According to the method of Patent Literature 1, an end date can be set in a smart contract, and data cannot be recorded in a blockchain linked to a smart contract beyond the end date.

### CITATION LIST

### Patent Literature

Patent Literature 1: JP 2019-008791 A

### SUMMARY OF INVENTION

### Technical Problem

A blockchain linked to a smart contract beyond an end date may be deleted. However, Patent Literature 1 does not disclose a method of deleting such a blockchain.

Assuming that a system administrator executes an operation of deleting a blockchain as necessary, time and labor that accompany operating the blockchain are large. The system administrator is a person who manages a system having the blockchain.

An objective of the present disclosure is to provide a device for deleting a distributed ledger so that the system administrator need not delete the distributed ledger.

### Solution to Problem

A management device according to the present disclosure includes:

a storage unit in which information indicating a ledger-deleting condition is recorded, the ledger-deleting condition being a condition for deleting a deletion distributed ledger which is a distributed ledger to record distributed electronic data; and

a ledger deletion unit to delete the deletion distributed ledger if the ledger-deleting condition is satisfied.

### Advantageous Effects of Invention

According to the present disclosure, a ledger deletion unit deletes a distributed ledger if a ledger-deleting condition is satisfied.

Therefore, according to the present disclosure, a system administrator need not delete the distributed ledger.

### BRIEF DESCRIPTION OF DRAWINGS

FIG. 1 illustrates a configuration example of a management system 90 according to Embodiment 1.

FIG. 2 illustrates a configuration example of the management system 90 in a case where a plurality of organizations operate the management system 90 according to Embodiment 1.

FIG. 3 illustrates a hardware configuration example of the management system 90 according to Embodiment 1.

FIG. 4 illustrates a software configuration example of the management system 90 according to Embodiment 1.

FIG. 5 illustrates a configuration example of a status management unit 130 according to Embodiment 1.

FIG. 6 illustrates a software configuration example of the management system 90 according to Embodiment 1.

FIG. 7 is a flowchart illustrating a setting process according to Embodiment 1.

FIG. 8 is a flowchart illustrating a status auto-update process according to Embodiment 1.

FIG. 9 is a flowchart illustrating a timing checking process according to Embodiment 1.

FIG. 10 is a flowchart illustrating an auto-generation process according to Embodiment 1.

FIG. 11 is a flowchart illustrating an auto-deletion process according to Embodiment 1.

FIG. 12 is a flowchart illustrating a generation checking process according to Embodiment 1.

FIG. 13 is a flowchart illustrating a deletion checking process according to Embodiment 1.

FIG. 14 illustrates a hardware configuration example of a management device 100 according to a modification of Embodiment 1.

### DESCRIPTION OF EMBODIMENTS

In description of the embodiment and drawings, the same elements and the equivalent elements are denoted by the same reference sign. An explanation of an element denoted by the same reference sign will be appropriately omitted or simplified. Arrows in the drawings mainly express data flows or process flows.

### Embodiment 1

A present embodiment will be described in detail with referring to drawings.

* * * Description of Configuration * * *

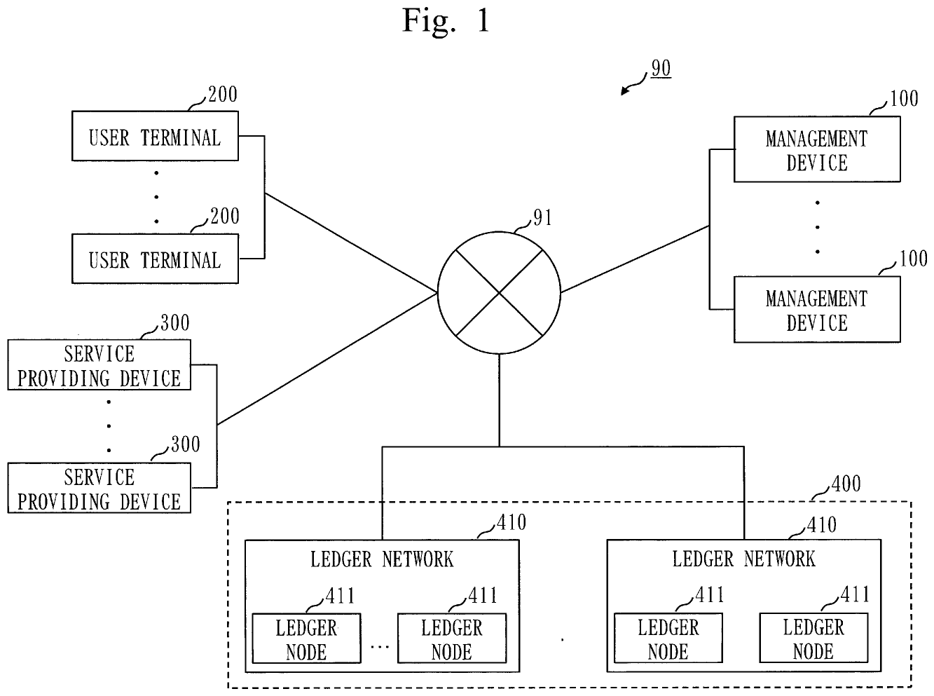

FIG. 1 illustrates a configuration example of a management system 90 according to the present embodiment. The management system 90 is also called a distributed ledger management system.

The management system 90 is provided with a management device 100, a user terminal 200, a service providing device 300, and a ledger network group 400, as illustrated in FIG. 1. The management device 100 is also called a distributed ledger management device. The ledger network group 400 is also called a distributed ledger network group. A distributed ledger records distributed electronic data. A specific example of the distributed ledger is a blockchain. If the distributed ledger is a blockchain, the distributed ledger typically signifies a blockchain as a whole.

The management system 90 may be provided with another management device 100 having a function of the management device 100. The management device 100 and another management device 100 suitably have the same function.

The management device 100, the user terminal 200, the service providing device 300, and the ledger network group 400 are connected to each other via a network 91. The network 91 is a communication network. A specific example of the network 91 is one or a combination of the Internet and an intranet.

Some of the management device 100, user terminal 200, service providing device 300, and ledger network group 400 need not be connected to each other.

The management device 100 manages the distributed ledger by managing one or more ledger nodes 411. The management device 100 sets a management rule and manages the ledger node 411 according to the management rule. The management rule is a rule that manages the distributed ledger. The management rule is inputted from the user terminal 200. In a specific example, the management rule relates to automatically generating a distributed ledger being a management target and automatically deleting a distributed ledger. The management device 100 generates a distributed ledger newly and deletes a distributed ledger.

In the present specification, “automatic” or “in an automatic manner” is an expression describing an operation of the management device 100 or the like from the viewpoint of an administrative user, unless otherwise noted. That is, the expression “automatic” or “in an automatic manner” is used to describe execution of a process by the management device 100 on the basis of information being set by the administrative user. The administrative user manages the distributed ledger by, for example, managing ledger setting information. The administrative user need not be a person but can be, for example, a computer. A plurality of users may be administrative users.

The user terminal 200 communicates with the management device 100 via the service providing device 300. The administrative user enters the ledger setting information with using the user terminal 200. The ledger setting information includes information indicating setting of the management device 100 and information indicating the management rule. The ledger setting information may include information corresponding to at least one of network information 13a, status information 13b, status rule information 13c, auto-update rule information 13d, and building means information 13e.

The user terminal 200 transmits setting information to the service providing device 300.

The service providing device 300 is a server that provides a service to the administrative user. The administrative user manages a service oriented to a user of an application that utilizes the distributed ledger as a data storage area. The application signifies an application program unless otherwise noted. In a specific example, the application is a business application or a Web application. The management rule is a rule to manage or control the distributed ledger.

The ledger network group 400 is provided with at least one ledger network 410. The ledger network 410 is also called a distributed ledger network.

The ledger network 410 is a network that operates a distributed ledger and is provided with at least one ledger node 411.

The ledger node 411 forms the ledger network 410. The ledger node 411 stores the distributed ledger.

The management system 90 may be provided with a plurality of management devices 100, a plurality of user terminals 200, and a plurality of service providing devices 300.

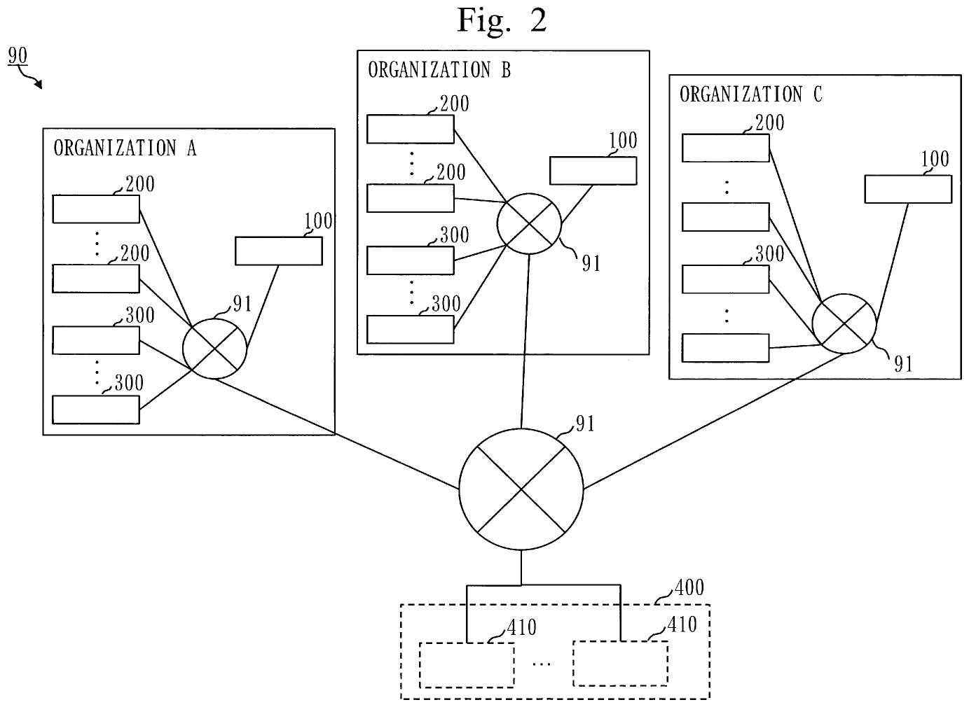

FIG. 2 illustrates an overall configuration example of the management system 90 in a case where a plurality of organizations utilize one management system 90. Each of an organization A, an organization B, and an organization C has a management device 100. An organization may be a divisional unit of an organization, which is, for example, a department.

The individual organizations belong to one management system 90 and are connected to each other via the network 91. The management device 100 of the organization A is connected to the management device 100 of the organization B and the management device 100 of the organization C via the network 91.

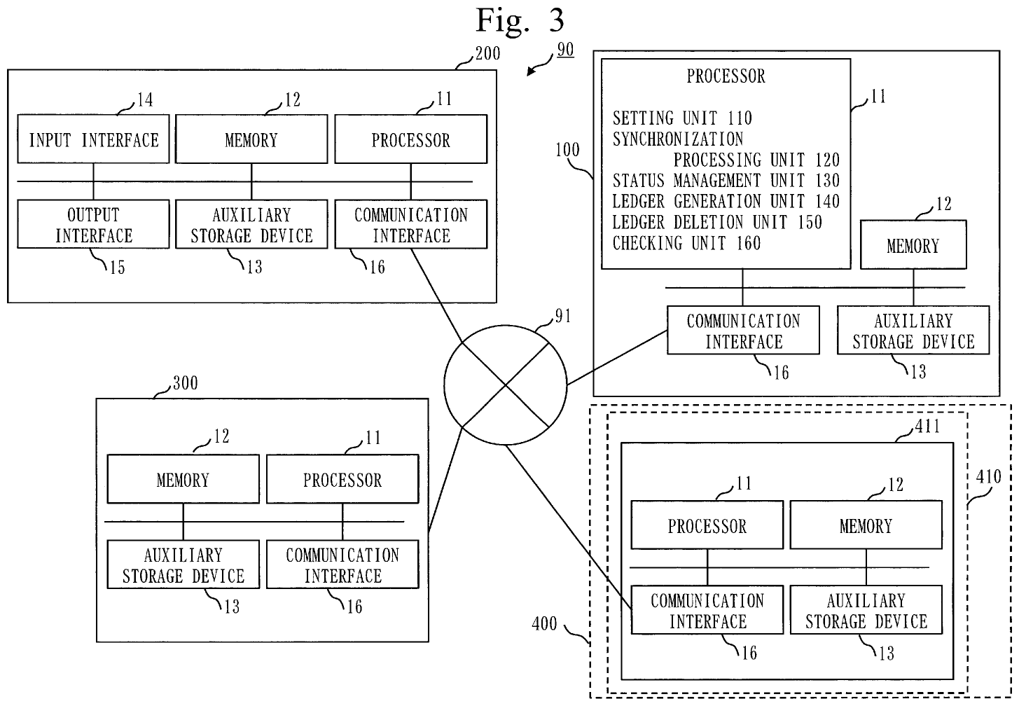

FIG. 3 illustrates a hardware configuration example of the management system 90. FIG. 3 illustrates a case where the management system 90 is provided with one management device 100, one user terminal 200, one service providing device 300, and a ledger network group 400 having one ledger network 410 provided with one ledger node 411.

Each of the management device 100, the user terminal 200, the service providing device 300, and the ledger node 411 is a computer. The computer may be formed of a plurality of computers.

Each of the management device 100, the service providing device 300, and the ledger node 411 is provided with a processor 11, a memory 12, an auxiliary storage device 13, and a communication interface 16. The hardware devices provided to the computer are connected to each other via a signal line.

The processor 11 is an Integrated Circuit (IC) that performs a computation process, and controls the hardware devices provided to the computer. A specific example of the processor 11 is a Central Processing Unit (CPU), a Digital Signal Processor (DSP), or a Graphics Processing Unit (GPU).

The management device 100 may be provided with a plurality of processors that replace the processor 11. The plurality of processors share roles of the processor 11.

The memory 12 is typically a volatile storage device. The memory 12 is also called a main storage device or a main memory. A specific example of the memory 12 is a Random-Access Memory (RAM). Data stored in the memory 12 is saved in the auxiliary storage device 13 as necessary. Data signifies electronic data unless otherwise noted.

The auxiliary storage device 13 is typically a non-volatile storage device. A specific example of the auxiliary storage device 13 is a Read-Only Memory (ROM), a Hard Disk Drive (HDD), or a flash memory. Data stored in the auxiliary storage device 13 is loaded to the memory 12 as necessary.

The memory 12 and the auxiliary storage device 13 may be formed integrally.

The communication interface 16 is a receiver/transmitter. A specific example of the communication interface 16 is a communication chip or a Network Interface Card (NIC).

Individual units in the management device 100 may use the communication interface 16 as necessary when communicating with other devices or the like, and may use the input interface 14 or the output interface 15 as necessary when inputting and outputting data.

A management program is stored in the auxiliary storage device 13 provided to the management device 100. The management program is a program that causes the computer to implement functions of the individual units provided to the management device 100. The management program may implement the individual units illustrated in FIG. 3. The management program is loaded to the memory 12 and run by the processor 11. The functions of the individual units provided to the management device 100 are implemented by software.

A server application is stored in the auxiliary storage device 13 provided to the service providing device 300.

Data used when running the management program, data obtained by running the management program, and so on are stored in a storage device as necessary. The individual units in the management device 100 utilize the storage device as necessary. In a specific example, the storage device is formed of at least one of the memory 12, the auxiliary storage device 13, a register in the processor 11, and a cache memory in the processor 11. Data and information may have the same meaning. The storage device may be independent of the computer.

The function of the memory 12 and the function of the auxiliary storage device 13 may be implemented by another storage device.

The management program may be recorded on a computer-readable non-volatile recording medium. A specific example of the non-volatile recording medium is an optical disk or a flash memory. The management program may be provided in the form of a program product.

Any program described in the present specification may be recorded on a computer-readable non-volatile recording medium. A specific example of the non-volatile recording medium is an optical disk or a flash memory.

A specific example of the user terminal 200 is a smartphone or a tablet terminal.

The user terminal 200 is provided with a processor 11, a memory 12, an auxiliary storage device 13, an input interface 14, an output interface 15, and a communication interface 16. The input interface 14 is also called an information input interface. The output interface 15 is also called a result output interface.

The input interface 14 is a port to which an input appliance is connected. A specific example of the input interface 14 is a Universal Serial Bus (USB) terminal. The input appliance is an appliance such as a keyboard and a mouse, that operates the computer.

The output interface 15 is a port to which an output appliance is connected. A specific example of the output interface 15 is a USB terminal or a High-Definition Multimedia Interface (HDMI, registered trademark) terminal. The output appliance is an appliance such as a Liquid Crystal Display (LCD), that can output information.

The input interface 14 and the output interface 15 may be formed integrally into an input/output interface. A specific example of the input/output interface is a touch panel.

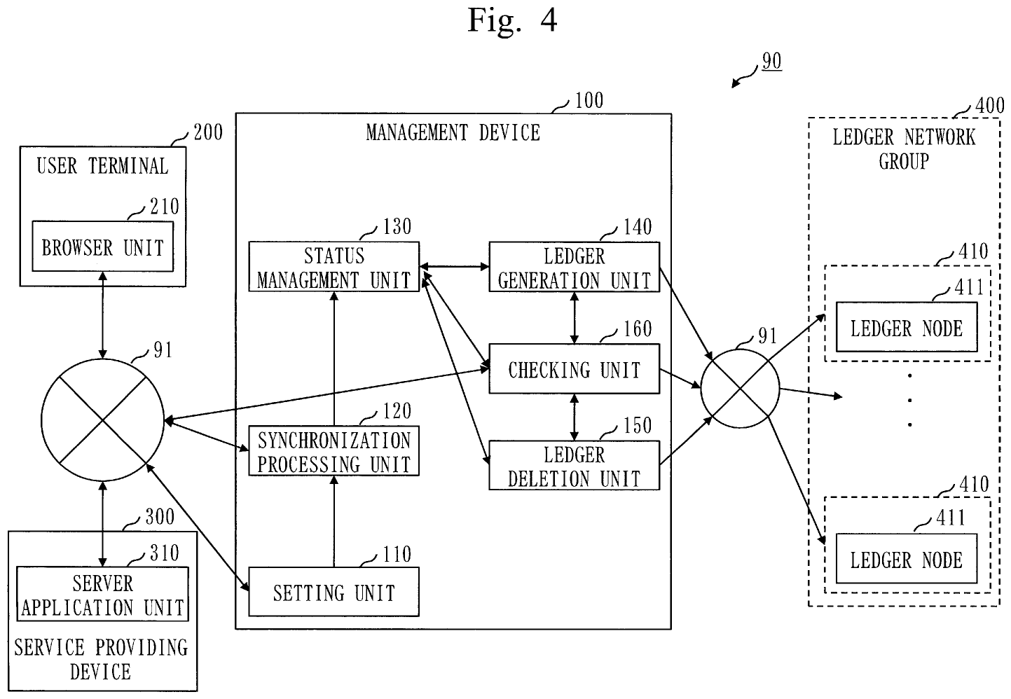

FIG. 4 illustrates a software configuration example of the management system 90. FIG. 4 corresponds to a case where a plurality of organizations operate one management system 90. Each organization being one of the plurality of organizations has a management device 100.

The management device 100 is provided with a setting unit 110, a synchronization processing unit 120, a status management unit 130, a ledger generation unit 140, a ledger deletion unit 150, and a checking unit 160, as illustrated in FIG. 4.

The setting unit 110 sets the ledger setting information. In a specific example, the setting unit 110 records a function of a status to be added to the distributed ledger, the status rule information 13c, the auto-update rule information 13d, the building means information 13e, and so on. The status signifies the status of the distributed ledger unless otherwise noted.

Via the service providing device 300, the administrative user transmits data to be set in the setting unit 110. The setting unit 110 sets the received data to the status management unit 130.

The synchronization processing unit 120 shares the ledger setting information with another management device 100 by synchronization. Another management device 100 signifies a management device 100 possessed by another organization.

The synchronization processing unit 120 shares the ledger setting information entered by the administrative user with the individual management devices 100 possessed by the plurality of organizations.

In a specific example, when three organizations which are the organization A, the organization B, and the organization C utilize one management system 90, the synchronization processing unit 120 of the organization A accepts the ledger setting information from the setting unit 110 of the organization A, and shares the ledger setting information with individual synchronization processing units 120 of the organization B and the organization C via the network. After that, the individual synchronization processing units 120 transmit the setting information to the status management units 130 of the individual organizations. Thus, the management devices 100 of the organization A, organization B, and organization C complete setting together at once.

The status management unit 130 updates the status of the distributed ledger managed by the management device 100 on the basis of the ledger setting information or rule information. On the basis of the updated information, the status management unit 130 instructs the ledger generation unit 140 to generate a distributed ledger, or instructs the ledger deletion unit 150 to delete the distributed ledger.

The status management unit 130 may instruct the ledger generation unit 140 to generate a generation distributed ledger if a ledger-generating condition is satisfied. The status management unit 130 may instruct the ledger deletion unit 150 to delete a deletion distributed ledger if a ledger-deleting condition is satisfied.

The ledger generation unit 140 generates a distributed ledger in response to an instruction from the status management unit 130, and transmits network information of the generated distributed ledger to the status management unit 130. Generating a distributed ledger signifies, in a specific example, setting a ledger node by the ledger generation unit 140 so that the ledger node exercises a function of the distributed ledger.

In a case where another management device 100 has generated a distributed ledger that the ledger generation unit 140 is planned to generate, the ledger generation unit 140 may regard that the ledger generation unit 140 has generated the distributed ledger that another management device 100 has generated. The ledger generation unit 140 may generate a generation distributed ledger if the ledger-generating condition is satisfied.

The ledger deletion unit 150 deletes a distributed ledger in response to an instruction from the status management unit 130, and transmits network information of the deleted distributed ledger to the status management unit 130. Deleting a distributed ledger signifies, in a specific example, setting a ledger node by the ledger deletion unit 150 so that the ledger node ceases to exercise the function of the distributed ledger.

In a case where another management device 100 has deleted a distributed ledger that the ledger deletion unit 150 is planned to delete, the ledger deletion unit 150 may regard that the ledger deletion unit 150 has deleted the distributed ledger that another management device 100 has deleted. The ledger deletion unit 150 may delete a deletion distributed ledger if the ledger-deleting condition is satisfied.

The checking unit 160 checks whether or not distributed ledgers operated in the other organizations are generated equally, or are deleted equally, on the basis of a rule managed by the status management unit 130.

In a case where the ledger generation unit 140 has generated a generation distributed ledger, the checking unit 160 checks whether or not a ledger generation unit 140 of another management device 100 has generated a generation distributed ledger. In a case where the ledger deletion unit 150 has deleted a deletion distributed ledger, the checking unit 160 checks whether or not a ledger deletion unit 150 of another management device 100 has deleted a deletion distributed ledger.

The user terminal 200 is provided with a browser unit 210. The user terminal 200 is a terminal for setting information or the like necessary for the management device 100 to generate or delete a distributed ledger automatically.

The browser unit 210 is an information display application such as a Web browser and a dedicated application. The browser unit 210 has a function necessary for the administrative user to enter information, and a function of outputting information received from devices.

The service providing device 300 is provided with a server application unit 310. The service providing device 300 has a function of transferring the information entered in the user terminal 200 by the administrative user to the setting unit 110. The service providing device 300 also has a function of transferring the information outputted by the management device 100 to the user terminal 200.

The ledger network group 400 has one or more ledger networks 410.

The ledger network 410 has one or more ledger nodes 411.

The ledger node 411 stores distribution-managed electronic data and distributes and manages the same information among a plurality of nodes in the ledger network. A specific example of the electronic data is transaction data.

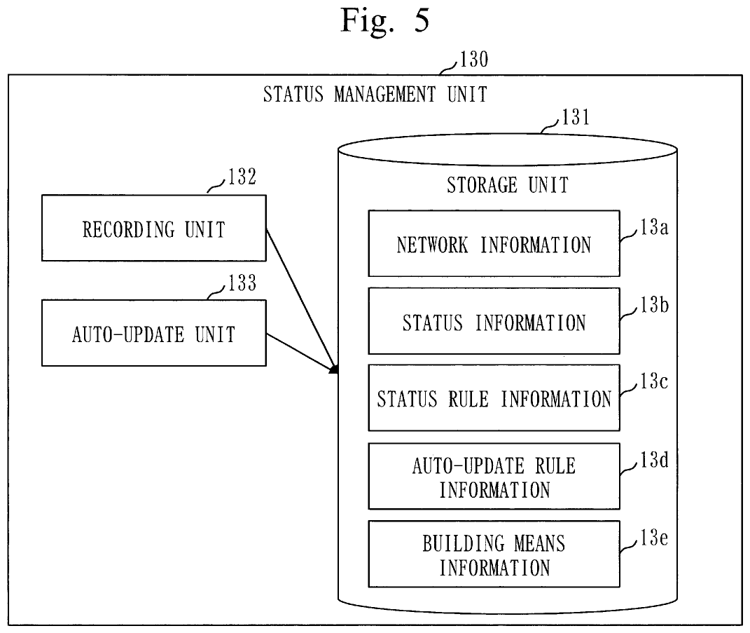

FIG. 5 illustrates a configuration example of the status management unit 130. The status management unit 130 is provided with a storage unit 131, a recording unit 132, and an auto-update unit 133, as illustrated in FIG. 5.

The storage unit 131 holds the ledger network information 13a, the status information 13b, the status rule information 13c, the auto-update rule information 13d, and the distributed-ledger building means information 13e. The storage unit 131 may hold another information. The ledger network information 13a, the status information 13b, the status rule information 13c, the auto-update rule information 13d, and the distributed-ledger building means information 13e refer to those held by the storage unit 131, unless otherwise noted.

The auto-update rule information 13d is also information indicating the ledger-generating condition and an update timing. The update timing is a timing to check whether or not at least one of the ledger-generating condition and ledger-deleting condition is satisfied.

The status management unit 130 checks whether or not at least one of the ledger-generating condition and the ledger-deleting condition is satisfied at the update timing.

The network information 13a is network information necessary for the management device 100 to communicate with a distributed ledger possessed by its own organization or with a management device 100 possessed by another organization. A specific example of the network information 13a is node configuration information of the distributed ledger, address information of the node, or network information of the management device 100 possessed by another organization.

The status information 13b indicates a present status of an individual distributed ledger operated by the management system 90.

The status rule information 13c indicates a type of status to be added to the distributed ledger, a function to be added to the distributed ledger, or a condition for status transition. The status rule information 13c includes information indicating the “ledger-generating condition” and information indicating the “ledger-deleting condition”. The “ledger-generating condition” is a condition under which the management device 100 generates a generation distributed ledger which is a distributed ledger. The “ledger-deleting condition” is a condition under which the management device 100 deletes a deletion distributed ledger which is a distributed ledger. The information indicating the “ledger-generating condition” and the information indicating the “ledger-deleting condition” are recorded in the storage unit 131.

In a specific example, the status rule information 13c may include a rule of: generating a distributed ledger when a predetermined condition is satisfied; operating the distributed ledger for 1 year under status 1 after the distributed ledger is generated; after that, operating the distributed ledger for 1 year under status 2; newly generating another distributed ledger at a timing the status of the distributed ledger becomes status 2; and deleting a distributed ledger for which status 2 has ended. The condition for status transition may be that a predetermined period of time has passed after the last transition, or that a data amount has reached a predetermined value; or a combination of these conditions.

The auto-update rule information 13d indicates a condition or a rule of updating the status of the distributed ledger automatically on the basis of the status rule information 13c.

In a specific example, the auto-update rule information 13d may include a rule of checking the status rule information 13c every day at 0:00 and updating the status information.

The building means information 13e indicates a means of building a distributed ledger. In a specific example, the building means information 13e includes information of a hardware resource or virtual hardware resource required by the distributed ledger, information of a procedure of installing distributed ledger software, and information concerning how to set an environment of the distributed ledger based on the ledger network information 13a.

The recording unit 132 records information to the storage unit 131.

The auto-update unit 133 updates the status information 13b on the basis of the auto-update rule information 13d recorded in the storage unit 131.

In a specific example, when there is a rule of checking the status rule information 13c every day at 0:00 and updating the status information 13b, the auto-update unit 133 executes the process according to this rule. In this process, if a condition for auto-generation is satisfied, the auto-update unit 133 instructs the ledger generation unit 140 to generate a distributed ledger. If a condition for auto-deletion is satisfied, the auto-update unit 133 instructs the ledger deletion unit 150 to delete a distributed ledger. Auto-generation signifies generation of a distributed ledger by the management device 100. Auto-deletion signifies deletion of a distributed ledger by the management device 100.

Typically, the storage unit 131 is formed of a storage device. The storage unit 131 may be of any mode as far as it is a storage area provided with an input/output means. The storage unit 131 may be installed outside the management device 100. A specific example of the storage unit 131 is a file system or a database.

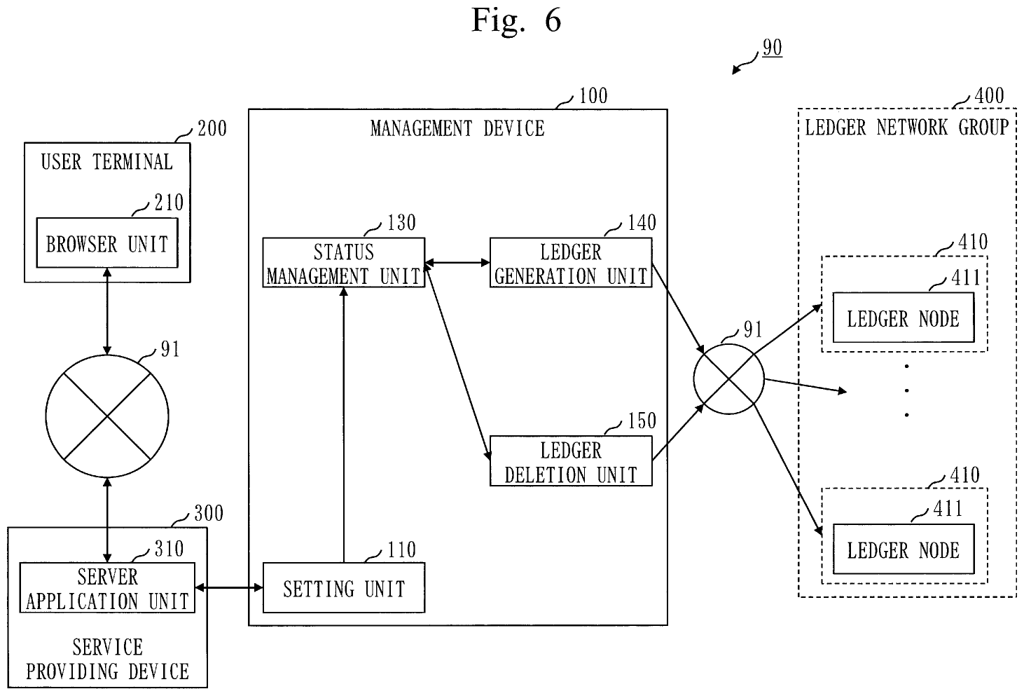

FIG. 6 illustrates a software configuration example of the management system 90 in a case where one organization operates this system. A difference in FIG. 6 from FIG. 4 is that a synchronization processing unit 120 and a checking unit 160 do not exist.

Except for functions concerning the synchronization processing unit 120 and the checking unit 160, the management system 90 illustrated in FIG. 6 is the same as the management system 90 illustrated in FIG. 4.

*** Description of Operations ***

An operation procedure of the management device 100 corresponds to a management method. A program that implements operations of the management device 100 corresponds to the management program.

Note that information having the same name is not necessarily formed of the same bit string or the like. A request may signify data.

When a plurality of organizations utilizes one management system 90, each of the plurality of organizations manages a distribution ledger and operates the management device 100, thereby managing the distribution ledger. That is, the plurality of organizations operate a plurality of distributed ledgers simultaneously, and also operate the management devices 100 for managing the plurality of distributed ledgers. Unless otherwise noted, the distributed ledger signifies a distributed ledger operated by one of the plurality of organizations.

In a specific example, note that each distributed ledger takes two ledger statuses which are “status 1” and “status 2”, and that status transition occurs every predetermined period of time in an order of “status 1”—>“status 2”. In this example, assume that the status rule information 13c includes information necessary for realizing this.

At a transition timing indicated by the transition rule, the administrative user may update the status in place of the management device 100 changing the status. Still, an example of auto-update will be described below. The auto-update unit 133 executes status auto-update. Auto-update signifies update of the status by the management device 100.

The number of organizations signifies the number of organizations that utilize the management system 90, unless otherwise noted. Another organization is an organization that is different from a certain organization and is one of the plurality of organizations.

In description of following flowcharts, in principle, the management device 100 which is a subject in the first step of each flowchart will be merely expressed as the management device 100, and individual units in that management device 100 will be expressed merely by names of those individual units in the management device 100. In a case where there are a plurality of management devices 100 in the management system 90, management devices 100 that are different from the management device 100 being the subject in the first step of each flowchart will be expressed as other management devices 100, and individual units in the other management devices 100 will be expressed as other individual units. The management device 100 and the other management devices 100 manage the same distributed ledger.

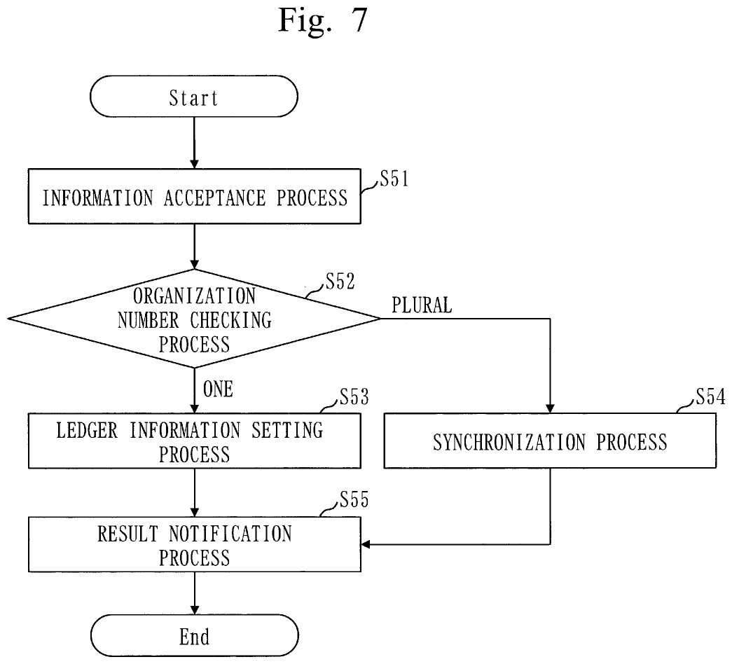

FIG. 7 is a flowchart illustrating an example of a setting process. A specific example of the setting process will be described with referring to FIG. 7. In the setting process, the administrative user sets information concerning the distributed ledger, such as the status rule information 13c, the auto-update rule information 13d, and the building means information 13e.

(Step S51: Information Acceptance Process)

The management device 100 accepts the ledger setting information. In a description below of this flowchart, the ledger setting information signifies information which the management device 100 accepts in step S51.

In step S51, in a specific example, first, the administrative user enters the ledger setting information to the browser unit 210.

Subsequently, the browser unit 210 transmits the ledger setting information to the server application unit 310.

Subsequently, the server application unit 310 transmits the ledger setting information to the setting unit 110.

Subsequently, the setting unit 110 checks a request corresponding to the ledger setting information.

(Step S52: Organization Number Checking Process)

The setting unit 110 checks the number of organizations.

If there are a plurality of organizations, the management device 100 proceeds to step S54. Otherwise, the management device 100 proceeds to step S53.

(Step S53: Ledger Information Setting Process)

The management device 100 sets the ledger setting information.

In this step, in a specific example, first, the setting unit 110 sends the ledger setting information to the status management unit 130.

Subsequently, the storage unit 131 records the ledger setting information.

Subsequently, the status management unit 130 sends result information to the setting unit 110. The result information indicates an execution result of the storage unit 131.

(Step S54: Synchronization Process)

The synchronization processing unit 120 shares the ledger setting information with the other management devices 100.

In this step, in a specific example, first, the setting unit 110 sends the ledger setting information to the synchronization processing unit 120.

Subsequently, the synchronization processing unit 120 transmits the ledger setting information to the synchronization processing units 120 of the individual other management devices 100 via the network.

Subsequently, the synchronization processing units 120 of the individual other management devices 100 send the ledger setting information to the status management units 130 of the individual other management devices 100.

Subsequently, the storage units 131 of the individual other management devices 100 record the ledger setting information.

Subsequently, the status management units 130 of the individual other management devices 100 send result information to the synchronization processing units 120 of the individual other management devices 100. The result information indicates execution results of the storage units 131 of the individual other management devices 100.

The synchronization processing units 120 of the individual other management devices 100 transmit the result information to the synchronization processing unit 120.

Subsequently, the synchronization processing unit 120 sends the received result information to the setting unit 110.

Also, in step S54, the synchronization processing unit 120 executes the same process as that of step S53.

(Step S55: Result Notification Process)

The setting unit 110 notifies the administrative user of the execution results.

In this step, in a specific example, first, the setting unit 110 transmits the result information to the server application unit 310.

Subsequently, the server application unit 310 sends this result information to the browser unit 210.

Subsequently, the browser unit 210 outputs this result information.

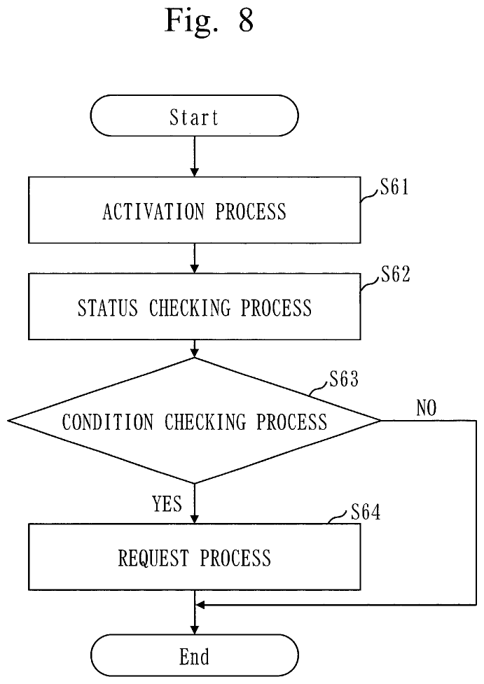

FIG. 8 is a flowchart illustrating an example of a status auto-update process. An example of the status auto-update process will be described with referring to FIG. 8. In a specific example, the status auto-update unit 133 updates the status in an order of “status 1” to “status 2”.

In the processing of this flowchart, the auto-update unit 133 refers to the information recorded in the storage unit 131.

(Step S61: Activation Process)

The auto-update unit 133 is activated at a time point an update timing is reached. The update timing is a timing to update the status. The auto-update unit 133 grasps an update timing by referring to the auto-update rule information 13d.

(Step S62: Status Checking Process)

When a condition indicated by the status rule information 13c is satisfied, the auto-update unit 133 updates the status information 13b according to the status rule information 13c.

(Step S63: Condition Checking Process)

The auto-update unit 133 checks whether the “ledger-generating condition” or the “ledger-deleting condition” is satisfied or not.

If either one of the “ledger-generating condition” and the “ledger-deleting condition” is satisfied, the management device 100 proceeds to step S64. Otherwise, the management device 100 ends processing of this flowchart.

(Step S64: Request Process)

When the “ledger-generating condition” is satisfied, the auto-update unit 133 transmits generation request information to the ledger generation unit 140 to request the ledger generation unit 140 to execute an auto-generation process. The generation request information is information that indicates requesting execution of the auto-generation process.

When the “ledger-deletion condition” is satisfied, the auto-update unit 133 transmits deletion request information to the ledger deletion unit 150 to request the ledger deletion unit 150 to execute an auto-deletion process. The deletion request information is information that indicates requesting execution of the auto-deletion process.

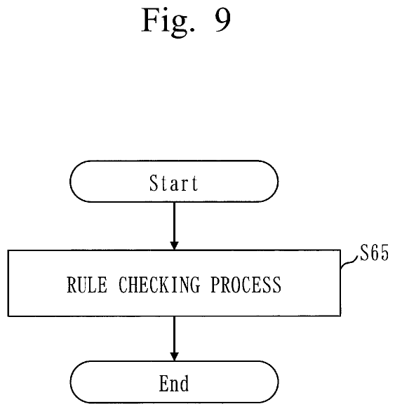

FIG. 9 is a flowchart illustrating an example of a timing checking process. An example of the timing checking process will be described with referring to FIG. 9.

When ledger setting information is newly recorded in the storage unit 131 or when ledger setting information is updated, the management device 100 executes the timing checking process.

(Step S65: Rule Checking Process)

The auto-update unit 133 checks an update timing by referring to the auto-update rule information 13d.

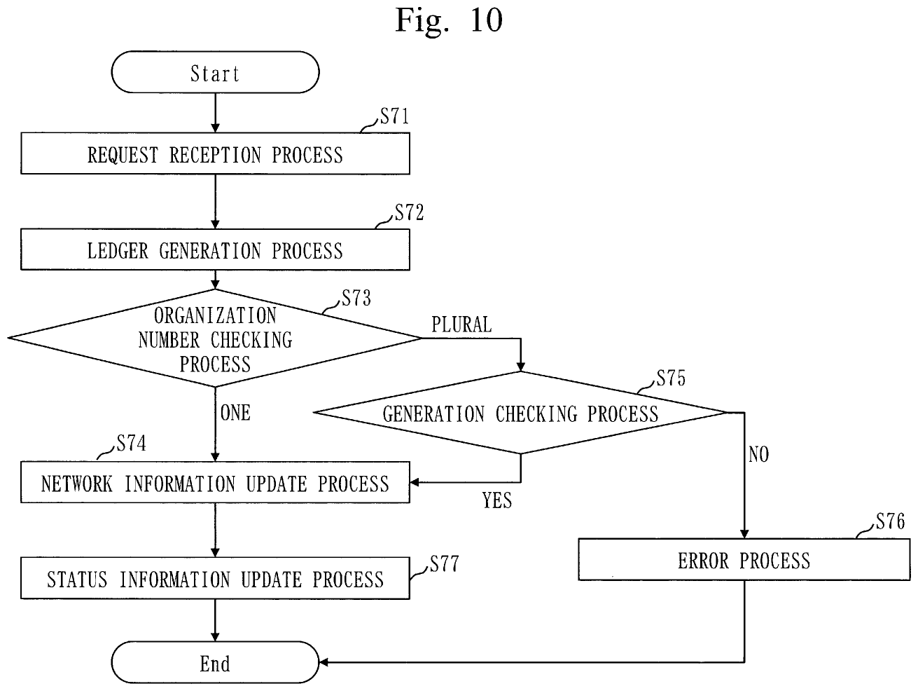

FIG. 10 is a flowchart illustrating an example of the auto-generation process. An example of the auto-generation process will be described with referring to FIG. 10. Triggered by a request from the auto-update unit 133 for the ledger generation unit 140 to execute the auto-generation process, the management device 100 executes processing of this flowchart.

(Step S71: Request Reception Process)

The ledger generation unit 140 receives the generation request information from the auto-update unit 133.

(Step S72: Ledger Generation Process)

The ledger generation unit 140 generates a distributed ledger as a generation distributed ledger with using the building means information 13e, according to the generation request information.

(Step S73: Organization Number Checking Process)

The ledger generation unit 140 checks whether or not there are a plurality of organizations.

If there are a plurality of organizations, the management device 100 proceeds to step S75. Otherwise, the management device 100 proceeds to step S74.

(Step S74: Network Information Update Process)

The ledger generation unit 140 sends network information corresponding to the generation distributed ledger to the status management unit 130.

The storage unit 131 updates the network information 13a by using this network information.

(Step S75: Generation Checking Process)

The management device 100 checks whether or not each of the other management devices 100 has generated a distributed ledger that is the same as the generation distributed ledger.

In this step, in a specific example, first, the ledger generation unit 140 requests the checking unit 160 to check that the other management devices 100 have generated distributed ledgers that are the same as the generation distributed ledger.

Subsequently, the checking unit 160 inquires each of the other checking units 160 whether or not a distributed ledger that is the same as the generation distributed ledger is generated.

Subsequently, each of the other checking units 160 executes a process corresponding to the inquiry from the checking unit 160.

If a distributed ledger that is the same as the generation distributed ledger is generated in every one of the other organizations, the management device 100 proceeds to step S74. Otherwise, the management device 100 proceeds to step S76.

(Step S76: Error Process)

The management device 100 executes an error process. The error process is a process which each unit in the management device 100 executes in accordance with an error content.

(Step S77: Status Information Update Process)

The storage unit 131 updates the status information 13b to correspond to having generated the distributed ledger.

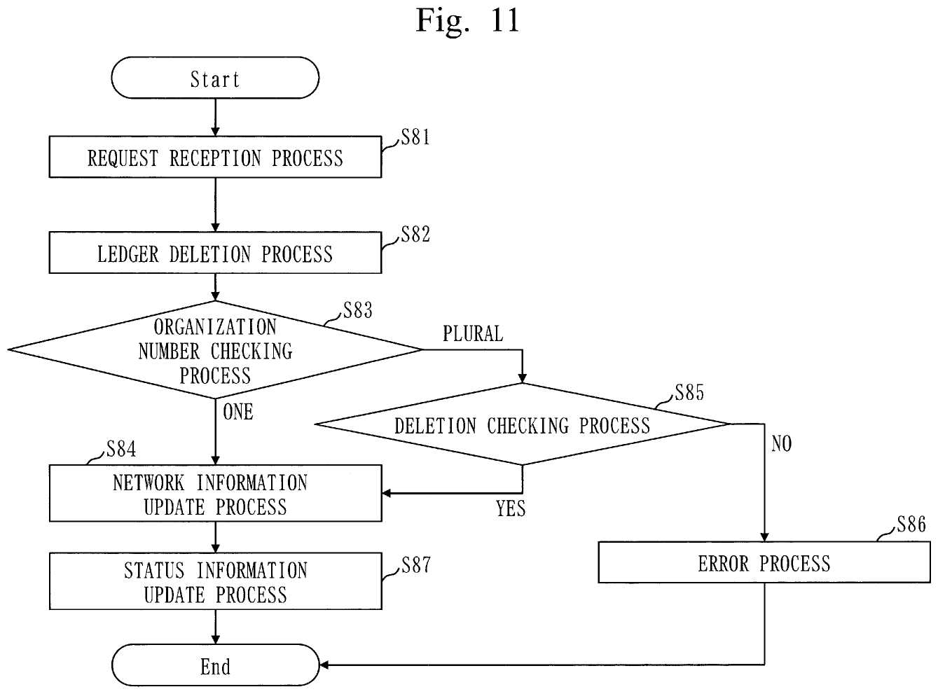

FIG. 11 is a flowchart illustrating an example of the auto-deletion process. An example of the auto-deletion process will be described with referring to FIG. 11. Triggered by a request from the auto-update unit 133 for the ledger deletion unit 150 to execute the auto-deletion process, the management device 100 executes processing of this flowchart.

(Step S81: Request Reception Process)

The ledger deletion unit 150 receives the deletion request information from the auto-update unit 133.

(Step S82: Ledger Deletion Process)

The ledger deletion unit 150 deletes the distributed ledger as a deletion distributed ledger in accordance with the deletion request information.

(Step S83: Organization Number Checking Process)

The ledger deletion unit 150 checks whether or not there are a plurality of organizations.

If there are a plurality of organizations, the management device 100 proceeds to step S85. Otherwise, the management device 100 proceeds to step S84.

(Step S84: Network Information Update Process)

The ledger deletion unit 150 sends network information of the deletion distributed ledger to the status management unit 130.

The storage unit 131 updates the network information 13a by using this network information.

(Step S85: Deletion Checking Process)

The management device 100 checks whether or not each of the other management devices 100 has deleted a distributed ledger that is the same as the deletion distributed ledger.

In this step, in a specific example, first, the ledger deletion unit 150 requests the checking unit 160 to check that the other management devices 100 have deleted distributed ledgers that are the same as the deletion distributed ledger.

Subsequently, the checking unit 160 inquires each of the other checking units 160 whether or not a distributed ledger that is the same as the deletion distributed ledger is deleted.

Subsequently, each of the other checking units 160 executes a process corresponding to the inquiry from the checking unit 160.

If a distributed ledger that is the same as the deletion distributed ledger is deleted in every one of the other organizations, the management device 100 proceeds to step S84. Otherwise, the management device 100 proceeds to step S86.

(Step S86: Error Process)

The management device 100 executes an error process.

(Step S87: Status Information Update Process)

The storage unit 131 updates the status information 13b to correspond to having deleted the deletion distributed ledger.

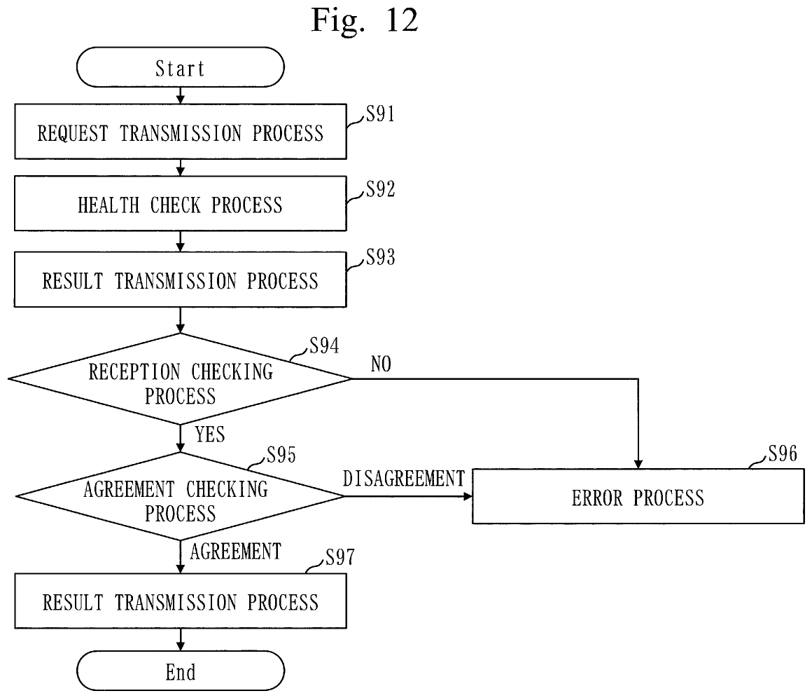

FIG. 12 is a flowchart illustrating an example of a generation checking process. An example of the generation checking process will be described with referring to FIG. 12. In a case where a plurality of organizations operate the same distributed ledger, when the auto-generation process is executed, the generation checking process is executed for a distributed ledger generated by the auto-generation process.

(Step S91: Request Transmission Process)

The ledger generation unit 140 requests the checking unit 160 to check an execution result of the auto-generation process.

(Step S92: Health Check Process)

The checking unit 160 executes health check for the auto-generation process. In a specific example, the checking unit 160 decides that a distributed ledger is successfully generated if normal communication with a distributed ledger corresponding to the auto-generation process is possible.

In this step, in a specific example, first, the checking unit 160 executes health check for a distributed ledger generated within its own organization.

Subsequently, the checking unit 160 generates a health check result. The health check result is information indicating a result of execution of the health check. In a description below of this flowchart, the health check result signifies a health check result generated in step S92.

(Step S93: Result Transmission Process)

The checking unit 160 transmits the health check result to each of the other checking units 160 by referring to the network information 13a.

(Step S94: Reception Checking Process)

The checking unit 160 checks whether or not it has received all health check results transmitted by the individual ones of the other checking units 160.

If the checking unit 160 has received the health check results within a predetermined period of time, the management device 100 proceeds to step S96. Otherwise, the management device 100 proceeds to step S95.

(Step S95: Agreement Checking Process)

The checking unit 160 checks whether or not the health check result of the checking unit 160 agrees with all the health check results received from the individual ones of the other checking units 160.

If there is a health check result that does not agree, or if a health check result cannot be received, the management device 100 proceeds to step S96. Otherwise, the management device 100 proceeds to step S97.

(Step S96: Error Process)

The management device 100 executes an error process.

(Step S97: Result Transmission Process)

The checking unit 160 transmits to the ledger generation unit 140 information indicating that the auto-generation process ended normally.

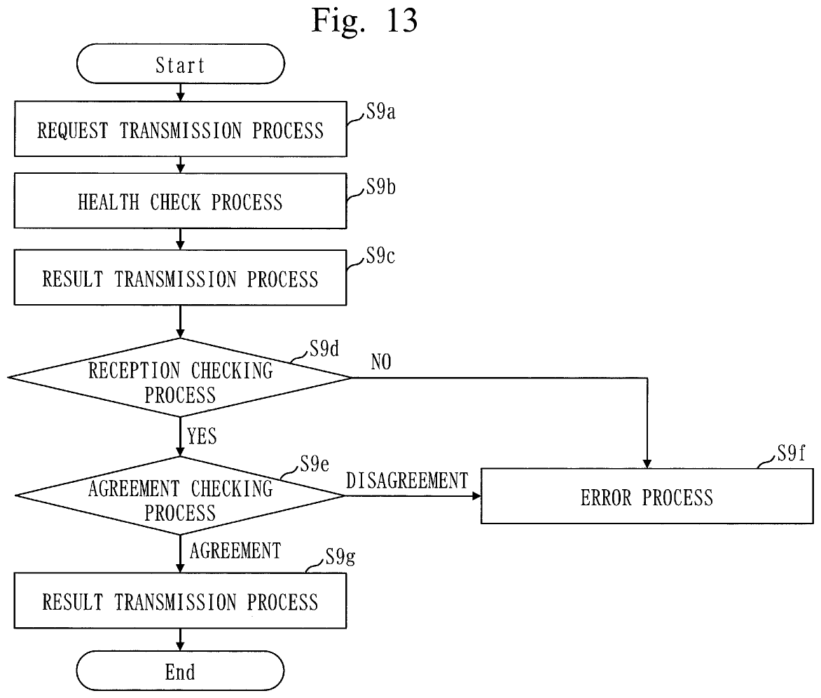

FIG. 13 is a flowchart illustrating an example of a deletion checking process. An example of the deletion checking process will be described with referring to FIG. 13. In a case where a plurality of organizations operate the same distributed ledger, when an auto-deletion process is executed, the deletion checking process is executed for a distributed ledger deleted by the auto-deletion process.

(Step S9a: Request Transmission Process)

The ledger deletion unit 150 requests the checking unit 160 to check an execution result of the auto-deletion process.

(Step S9b: Health Check Process)

This process is similar to the process of step S92 but the term “generation” is replaced by the term “deletion”.

(Step S9c: Result Transmission Process)

This process is the same as that of step S93.

(Step S9d: Reception Checking Process)

This process is the same as that of step S94.

(Step S9e: Agreement Checking Process)

This process is the same as that of step S95.

(Step S9f: Error Process)

This process is the same as that of step S96.

(Step S9g: Result Transmission Process)

The checking unit 160 transmits to the ledger deletion unit 150 information indicating that the auto-deletion process ended normally.

The above description of the flowchart of the generation checking process and the above description of the flowchart of the deletion checking process apply when a scheme in which the checking unit 160 trusts the health check results received from the other checking units 160 is employed.

When the checking unit 160 receives a health check result, the checking unit 160 may conduct health check for a server that has transmitted the health check result. This allows the checking unit 160 to check that the generation checking process or the deletion checking process is executed appropriately. Hence, the reliability of the generation checking process and the deletion checking process can be further enhanced.

*** Description of Effect of Embodiment 1 ***

As described above, according to the present embodiment, the management device 100 can automatically generate a distributed ledger and automatically delete a distributed ledger on the basis of a rule which the administrative user has set arbitrarily, while operating one or more distributed ledgers simultaneously.

The management device 100 is provided with the synchronization processing unit 120 and the checking unit 160. Thus, the management device 100 can check whether or not individual distributed ledgers possessed by the plurality of organizations are appropriately auto-generated or auto-deleted on the basis of the rule being set.

Therefore, according to the present embodiment, the administrative user need not generate or delete a distributed ledger. Accordingly, a load on the administrative user that accompanies operating the distributed ledger is reduced.

*** Other Configurations ***

<Modification 1>

The management device 100 may execute the auto-generation process and the auto-deletion process simultaneously if both the ledger-generating condition and the ledger-deleting condition are satisfied simultaneously.

In the present modification, in a specific example, in step S64, the auto-update unit 133 transmits generation request information to the ledger generation unit 140 and transmits deletion request information to the ledger deletion unit 150.

<Modification 2>

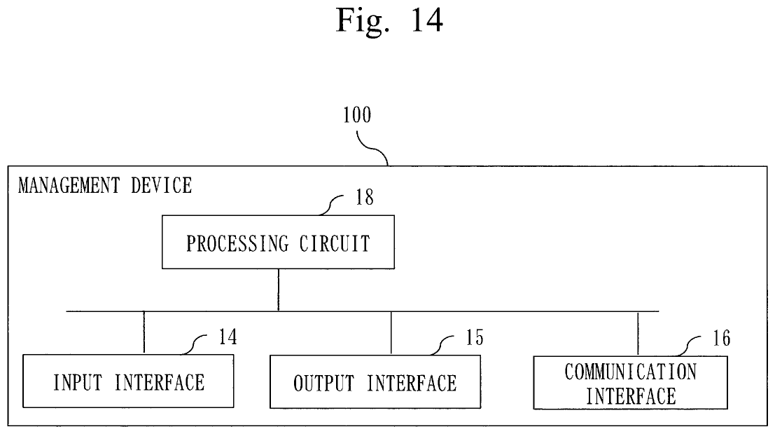

FIG. 14 illustrates a hardware configuration example of a management device 100 according to the present modification.

The management device 100 is provided with a processing circuit 18 in place of at least one of the processor 11, memory 12, and auxiliary storage device 13, as illustrated in FIG. 14.

The processing circuit 18 is hardware that implements at least one of individual units provided to the management device 100.

The processing circuit 18 may be dedicated hardware or may be a processor that runs a program stored in the memory 12.

If the processing circuit 18 is dedicated hardware, the processing circuit 18 is, in a specific example, one or a combination of a single circuit, a composite circuit, a programmed processor, a parallel-programmed processor, an Application Specific Integrated Circuit (ASIC), and a Field-Programmable Gate Array (FPGA).

The management device 100 may be provided with a plurality of processing circuits that substitute for the processing circuit 18. The plurality of processing circuits share roles of the processing circuit 18.

In the management device 100, some of the functions may be implemented by dedicated hardware, and the remaining functions may be implemented by software or firmware.

In a specific example, the processing circuit 18 is implemented by one or a combination of hardware, software, and firmware.

The processor 11, the memory 12, the auxiliary storage device 13, and the processing circuit 18 are collectively referred to as “processing circuitry”. That is, the functions of the individual function components of the management device 100 are implemented by processing circuitry.

Other devices described in the present specification may each have the same configuration as that of the present modification.

### Other Embodiments

The embodiments described above can be combined freely. An arbitrary component of each embodiment can be modified. An arbitrary component in each embodiment can be omitted.

Embodiments are not limited to what is described in Embodiment 1, but various changes can be made in the embodiments as necessary. Procedures described with using flowcharts and so on may be changed appropriately.

### REFERENCE SIGNS LIST

11: processor; 12: memory; 13: auxiliary storage device; 14: input interface; 15: output interface; 16: communication interface; 18: processing circuit; 90: management system; 91: network; 100: management device; 110: setting unit; 120: synchronization processing unit; 130: status management unit; 131: storage unit; 132: recording unit; 133: auto-update unit; 13a: network information; 13b: status information; 13c: status rule information; 13d: auto-update rule information; 13e: building means information; 140: ledger generation unit; 150: ledger deletion unit; 160: checking unit; 200: user terminal; 210: browser unit; 300: service providing device; 310: server application unit; 400: ledger network group; 410: ledger network; 411: ledger node.

1. A management device comprising:
processing circuitry in which information indicating a ledger-deleting condition is recorded, the ledger-deleting condition being a condition for deleting a deletion distributed ledger which is a distributed ledger to record distributed electronic data,
wherein the processing circuitry deletes the deletion distributed ledger if the ledger-deleting condition is satisfied,
wherein a management system comprising another management device comprises the management device, said another management device having a function of the management device, and
wherein the processing circuitry synchronizes the ledger-deleting condition with said another management device by transmitting the information indicating the ledger-deleting condition to said another management device.

2. The management device according to claim 1,
wherein information indicating a ledger-generating condition is recorded in the processing circuitry, the ledger-generating condition being a condition for generating a generation distributed ledger which is the distributed ledger, and
wherein the processing circuitry of the management device
generates the generation distributed ledger if the ledger-generating condition is satisfied, and
shares the ledger-generating condition by transmitting the information indicating the ledger-generating condition to said another management device.

3. The management device according to claim 2, wherein the processing circuitry
generates the generation distributed ledger if the ledger-generating condition is satisfied, and deletes the deletion distributed ledger if the ledger-deleting condition is satisfied.

4. The management device according to claim 3,
wherein information indicating an update timing is stored in the processing circuitry, the update timing being a timing to check whether or not at least one of the ledger-generating condition and the ledger-deleting condition is satisfied, and
wherein the processing circuitry
checks whether or not at least one of the ledger-generating condition and the ledger-deleting condition is satisfied at the update timing, and
synchronizes the update timing with said another management device by transmitting the information indicating the update timing to said another management device.

5. The management device according to claim 4,
wherein the processing circuitry of the management device checks, in a case where the processing circuitry of the management device has deleted the deletion distributed ledger, whether or not processing circuitry of said another management device has deleted the deletion distributed ledger.

6. The management device according to claim 5,
wherein the processing circuitry of the management device checks, in a case where the processing circuitry of the management device has generated the generation distributed ledger, whether or not the processing circuitry of said another management device has generated the generation distributed ledger.

7. The management device according to claim 1,
wherein status rule information indicating a condition for status transition of said distributed ledger is recorded in the processing circuitry of the management device, and
wherein the processing circuitry of the management device synchronizes the status rule information with said another management device by transmitting the status rule information to said another management device.

8. The management device according to claim 2,
wherein status rule information indicating a condition for status transition of said distributed ledger is recorded in the processing circuitry of the management device, and
wherein the processing circuitry of the management device synchronizes the status rule information with said another management device by transmitting the status rule information to said another management device.

9. The management device according to claim 3,
wherein status rule information indicating a condition for status transition of said distributed ledger is recorded in the processing circuitry of the management device, and
wherein the processing circuitry of the management device synchronizes the status rule information with said another management device by transmitting the status rule information to said another management device.

10. The management device according to claim 4,
wherein status rule information indicating a condition for status transition of said distributed ledger is recorded in the processing circuitry of the management device, and
wherein the processing circuitry of the management device synchronizes the status rule information with said another management device by transmitting the status rule information to said another management device.

11. The management device according to claim 5,
wherein status rule information indicating a condition for status transition of said distributed ledger is recorded in the processing circuitry of the management device, and
wherein the processing circuitry of the management device synchronizes the status rule information with said another management device by transmitting the status rule information to said another management device.

12. The management device according to claim 6,
wherein status rule information indicating a condition for status transition of said distributed ledger is recorded in the processing circuitry of the management device, and
wherein the processing circuitry of the management device synchronizes the status rule information with said another management device by transmitting the status rule information to said another management device.

13. A management device comprising:
processing circuitry in which information indicating a ledger-generating condition is recorded, the ledger-generating condition being a condition for generating a generation distributed ledger which is a distributed ledger to record distributed electronic data,
wherein the processing circuitry generates the generation distributed ledger if the ledger-deleting condition is satisfied,
wherein a management system comprising another management device comprises the management device, said another management device having a function of the management device, and
wherein the processing circuitry of the management device synchronizes the ledger-generating condition with said another management device by transmitting the information indicating the ledger-generating condition to said another management device.

14. A management method
wherein information indicating a ledger-deleting condition is recorded in a management device, the ledger-deleting condition being a condition for deleting a deletion distributed ledger which is a distributed ledger to record distributed electronic data,
the management method comprising
deleting the deletion distributed ledger if the ledger-deleting condition is satisfied, and
wherein a management system comprising another management device comprises the management device, said another management device having a function of the management device,
the management method comprising
synchronizing the ledger-deleting condition with said another management device by transmitting the information indicating the ledger-deleting condition to said another management device.

15. A management method
wherein information indicating a ledger-generating condition is recorded in a management device, the ledger-generating condition being a condition for generating a generation distributed ledger which is a distributed ledger to record distributed electronic data,
the management method comprising
generating the generation distributed ledger if the ledger-generating condition is satisfied, and
wherein a management system comprising another management device comprises the management device, said another management device having a function of the management device,
the management method comprising
synchronizing the ledger-generating condition with said another management device by transmitting the information indicating the ledger-generating condition to said another management device.

16. A non-transitory computer-readable recording medium recorded with a management program which causes a computer to delete a deletion distributed ledger if a ledger-deleting condition is satisfied,
wherein information indicating the ledger-deleting condition is recorded in the computer, the ledger-deleting condition being a condition for deleting the deletion distributed ledger which is a distributed ledger to record distributed electronic data, and
wherein a management system comprising another computer comprises the computer, said another computer having a function of the computer,
the management program causing the computer to synchronize the ledger-deleting condition with said another computer by transmitting the information indicating the ledger-deleting condition to said another computer.

17. A non-transitory computer-readable recording medium recorded with a management program which causes a computer to generate a generation distributed ledger if a ledger-generating condition is satisfied,
wherein information indicating the ledger-generating condition is recorded in the computer, the ledger-generating condition being a condition for generating the generation distributed ledger which is a distributed ledger to record distributed electronic data, and
wherein a management system comprising another computer comprises the computer, said another computer having a function of the computer,
the management program causing the computer to synchronize the ledger-generating condition with said another computer by transmitting the information indicating the ledger-generating condition to said another computer.
